(19) United States
(12) Patent Application Publication
(10) Pub. No.: US 2020/0384878 A1
(43) Pub. Date: Dec. 10, 2020

(54) MANAGEMENT APPARATUS, MANAGEMENT METHOD, AND STORAGE MEDIUM

(71) Applicant: HONDA MOTOR CO., LTD., Tokyo (JP)

(72) Inventors: Thomas Stephen Pontefract, Wako-shi (JP); Shinichi Yokoyama, Wako-shi (JP); Mitsuteru Yano, Wako-shi (JP); Yusaku Amari, Wako-shi (JP); Keiichiro Homma, Wako-shi (JP)

(21) Appl. No.: 16/882,904

(22) Filed: May 26, 2020

(30) Foreign Application Priority Data
May 28, 2019 (JP) 2019-099259

(51) Int. Cl. B60L 53/66; B60L 58/13; B60L 58/22

(52) U.S. Cl. CPC B60L 53/66; B60L 58/13; B60L 2240/72; B60L 2240/62; B60L 58/22

(57) ABSTRACT

A management apparatus that controls transmission and reception of electric power between a secondary battery mounted on a vehicle and accumulating the electric power used for traveling of the vehicle, and an electric power system, and includes an acquirer acquiring a position of the vehicle, a first specific location related to a user of the vehicle, and power storage information regarding the secondary battery, and a manager determining an amount of electric power supplied to the electric power system from the secondary battery only to the extent of a power storage amount obtained by subtracting a power storage amount with which the vehicle can travel from the position of the vehicle acquired by the acquirer to the first specific location from a power storage amount of the secondary battery.

### CROSS-REFERENCE TO RELATED APPLICATION

Priority is claimed on Japanese Patent Application No. 2019-099259, filed May 28, 2019, the content of which is incorporated herein by reference.

### BACKGROUND

### Field of the Invention

The present invention relates to a management apparatus, a management method, and a storage medium.

### Description of Related Art

In recent years, electrified vehicles have come to be widely used. Electrified vehicles have a secondary battery mounted thereon, accumulate electricity in the secondary battery, and travel by supplying electric power to a motor from the secondary battery during traveling. Thus, a user of an electrified vehicle accumulates electricity in the secondary battery of the electrified vehicle, for example, at charging stations provided at various locations or at a home of the user.

A social system called vehicle to grid (V2G) has been proposed. In the V2G, electric power is transmitted and received between an electric power system including a commercial electric power network and electrified vehicles (refer to PCT International Publication No. WO2018/084152). In the V2G, when an electrified vehicle is not used as moving means, a secondary battery mounted on the electrified vehicle is used like one of electric power storage facilities in a commercial electric power network. Thus, electric power is transmitted and received in a bidirectional manner between an electrified vehicle and an electric power system that participate in the V2G.

### SUMMARY

In the related art, for example, in a case where electric power is supplied to an electric power system from an on-vehicle secondary battery, it may be difficult for a vehicle to travel to a home during movement to the home due to an insufficient power storage amount of the on-vehicle secondary battery.

The present invention has been made in consideration of these circumstances, and one object thereof is to provide a management apparatus, a management method, and a storage medium capable of operating V2G while securing a minimum power storage amount.

The management apparatus, the management method, and the storage medium according to the present invention employ the following configurations.

(1): According to an aspect of the present invention, there is provided a management apparatus that controls transmission and reception of electric power between a secondary battery mounted on a vehicle and accumulating the electric power used for traveling of the vehicle, and an electric power system, the management apparatus including an acquirer acquiring a position of the vehicle, a first specific location related to a user of the vehicle, and power storage information regarding the secondary battery; and a manager determining an amount of electric power supplied to the electric power system from the secondary battery only to the extent of a power storage amount obtained by subtracting a power storage amount with which the vehicle can travel from the position of the vehicle acquired by the acquirer to the first specific location from a power storage amount of the secondary battery.

(2): In the aspect of the above (1), the first specific location is a position of a home of the user, the position being acquired or estimated in advance.

(3): In the aspect of the above (1), in a case where a charging facility is present at an intermediate position between the position of the vehicle and the first specific location, the manager sets a position of the charging facility as a second specific location, and determines an amount of electric power supplied to the electric power system from the secondary battery only to the extent of a power storage amount obtained by subtracting a power storage amount with which the vehicle can travel to the second specific location from the power storage amount of the secondary battery.

(4): In the aspects of the above (1), in a case where a third specific location being different from the first specific location is estimated as a destination of the vehicle on the basis of schedule information of the user of the vehicle, the manager determines an amount of electric power supplied to the electric power system from the secondary battery only to the extent of a power storage amount obtained by subtracting a power storage amount with which the vehicle can travel to the third specific location from the power storage amount of the secondary battery.

(5): In the aspects of the above (1), in a case where the position of the vehicle matches the first specific location, the manager determines an amount of electric power supplied to the electric power system from the secondary battery only to the extent of a power storage amount obtained by subtracting a power storage amount with which the vehicle can travel from the position of the vehicle to a fourth specific location being different from the first specific location, from the power storage amount of the secondary battery.

(6): In the aspect of the above (5), in a case where a charging facility is present at an intermediate position between the position of the vehicle and the fourth specific location, the manager sets a position of the charging facility as a fifth specific location, and determines an amount of electric power supplied to the electric power system from the secondary battery only to the extent of a power storage amount obtained by subtracting a power storage amount with which the vehicle can travel from the position of the vehicle to the fifth specific location from the power storage amount of the secondary battery.

(7): According to another aspect of the present invention, there is provided a management method of causing a computer to control transmission and reception of electric power between a secondary battery mounted on a vehicle and accumulating the electric power used for traveling of the vehicle, and an electric power system; acquire a position of the vehicle, a first specific location related to a user of the vehicle, and power storage information regarding the secondary battery; and determine an amount of electric power supplied to the electric power system from the secondary battery only to the extent of a power storage amount obtained by subtracting a power storage amount with which the vehicle can travel from the acquired position of the vehicle to the first specific location from a power storage amount of the secondary battery.

(8): According to still another aspect of the present invention, there is provided a storage medium storing a program causing a computer to control transmission and reception of electric power between a secondary battery mounted on a vehicle and accumulating the electric power used for traveling of the vehicle, and an electric power system; acquire a position of the vehicle, a first specific location related to a user of the vehicle, and power storage information regarding the secondary battery; and determine an amount of electric power supplied to the electric power system from the secondary battery only to the extent of a power storage amount obtained by subtracting a power storage amount with which the vehicle can travel from the acquired position of the vehicle to the first specific location from a power storage amount of the secondary battery.

According to the aspects of (1) to (8), it is possible to operate V2G while securing a minimum power storage amount.

### BRIEF DESCRIPTION OF THE DRAWINGS

FIG. 1 is a diagram illustrating examples of a configuration and a usage environment of a management apparatus according to a first embodiment.

FIG. 2 is a diagram illustrating an example of a configuration of a vehicle according to the first embodiment.

FIG. 3 is a diagram illustrating an example of charging data.

FIG. 4 is a flowchart for describing a flow of a series of processes in the management apparatus according to the first embodiment.

FIG. 5 is a diagram for describing an operation of the management apparatus according to the first embodiment.

FIG. 6 is a diagram for describing an operation of the management apparatus according to the first embodiment.

FIG. 7 is a diagram for describing an operation of the management apparatus according to the first embodiment.

FIG. 8 is a flowchart for describing a flow of a series of processes in a management apparatus according to a second embodiment.

FIG. 9 is a diagram for describing an operation of the management apparatus according to the second embodiment.

FIG. 10 is a diagram for describing an operation of the management apparatus according to the second embodiment.

FIG. 11 is a diagram illustrating an example of a configuration of a vehicle according to a third embodiment.

### DESCRIPTION OF EMBODIMENTS

Hereinafter, with reference to the drawings, embodiments of a management apparatus, a management method, and a program of the present invention will be described. In the following description, a vehicle is assumed to be an electric vehicle on which a secondary battery is mounted. However, the vehicle may be a hybrid vehicle or a fuel cell vehicle as long as the vehicle can accumulate electric power from the outside and has a secondary battery supplying electric power for traveling mounted thereon.

### First Embodiment

Hereinafter, a first embodiment will be described.

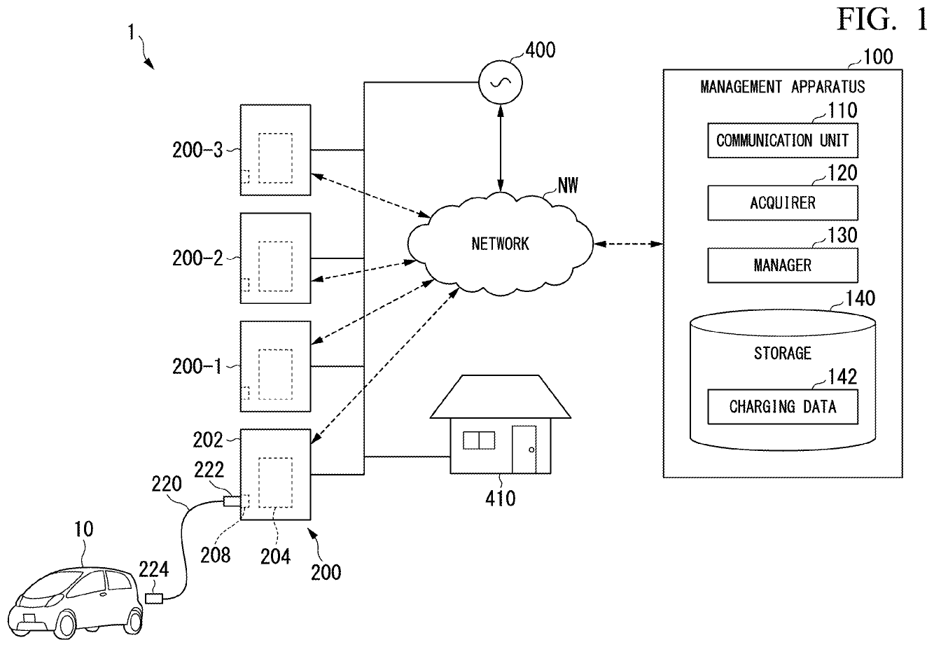

### Overall Configuration FIG. 1 is a

diagram illustrating examples of a configuration and a use environment of a vehicle to grid (V2G) system 1 including a management apparatus 100 according to the first embodiment. As illustrated in FIG. 1, the V2G system 1 includes the management apparatus 100, a plurality of charging/discharging apparatuses 200, 200-1, 200-2, and 200-3, a vehicle 10, and an electric power system 400. In FIG. 1, the charging/discharging apparatuses 200, 200-1, 200-2, and 200-3 are illustrated, but will be simply referred to as charging/discharging apparatuses 200 in a case where the charging/discharging apparatuses are not differentiated from each other.

The management apparatus 100 controls charging and discharging between a battery 40 mounted on the vehicle 10 and accumulating electric power used for traveling of the vehicle 10, and the electric power system 400. The electric power system 400 includes, for example, a power plant, a substation facility, a power transmission line, a power distribution facility, a transformer, and a protection relay system. The electric power system 400 is connected to one or more charging/discharging apparatuses 200. The charging/discharging apparatus 200 is provided in, for example, a home of a user of the vehicle 10, a company where the user works, or a lodging used by the user. The electric power system 400 supplies electric power to the vehicle 10 connected to the charging/discharging apparatus 200. The electric power system 400 is also connected to a building 410 such as a house, a factory, or a commercial facility in addition to the charging/discharging apparatus 200, and supplies electric power to the building 410.

### Vehicle

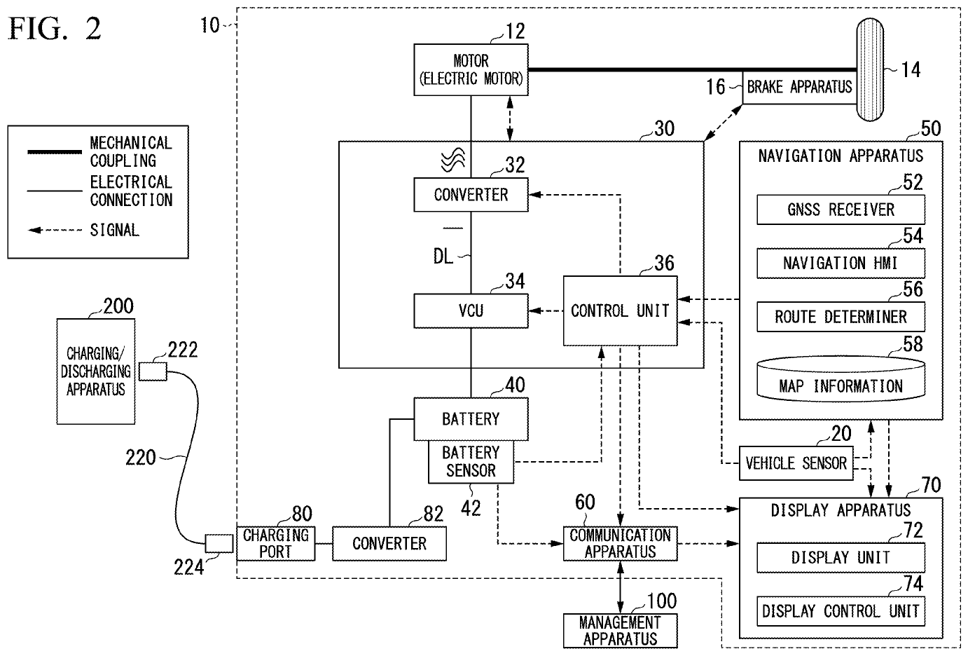

FIG. 2 is a diagram illustrating an example of a configuration of the vehicle 10. As illustrated in FIG. 2, the vehicle 10 is provided with, for example, a motor 12, drive wheels 14, a brake apparatus 16, vehicle sensors 20, a power control unit (PCU) 30, the battery 40, battery sensors 42 such as a voltage sensor, a current sensor, and a temperature sensor, a navigation apparatus 50, a communication apparatus 60, a display apparatus 70, a charging port 80, and a converter 82.

The motor 12 is, for example, a three-phase AC motor. A rotor of the motor 12 is coupled to the drive wheels 14. The motor 12 outputs a driving force to the drive wheels 14 by using supplied electric power. The motor 12 generates power by using kinetic energy of the vehicle 10 when the vehicle 10 is decelerated.

The brake apparatus 16 includes, for example, a brake caliper, a cylinder that transmits hydraulic pressure to the brake caliper, and an electric motor that generates the hydraulic pressure in the cylinder. The brake apparatus 16 may include a mechanism, as a backup, transmitting hydraulic pressure generated by operating a brake pedal to the cylinder via a master cylinder. The brake apparatus 16 is not limited the above-described configuration, and may be an electronic control type hydraulic brake apparatus that transmits hydraulic pressure in a master cylinder to a cylinder.

The vehicle sensors 20 include an accelerator opening degree sensor, a vehicle speed sensor, and a brake depression amount sensor. The accelerator opening degree sensor is attached to an accelerator pedal, detects an operation amount for the accelerator pedal, and outputs the operation amount as an accelerator opening degree to a control unit 36. The vehicle speed sensor includes, for example, a wheel speed sensor attached to each vehicle wheel, and a speed calculator, integrates wheel speeds detected by the wheel speed sensors to derive a speed of the vehicle (vehicle speed), and outputs the vehicle speed to the control unit 36 and the display apparatus 70. The brake depression amount sensor is attached to a brake pedal, detects an operation amount for the brake pedal, and outputs the operation amount as a brake depression amount to the control unit 36.

The PCU 30 includes, for example, a converter 32, a voltage control unit (VCU) 34, and the control unit 36. The integrated configuration of the constituent elements as the PCU 30 is only an example, and the constituent elements may be disposed in a distributed manner.

The converter 32 is, for example, an AC-DC converter. A DC side terminal of the converter 32 is connected to a DC link DL. The battery 40 is connected to the DC link DL via the VCU 34. The converter 32 converts AC power generated by the motor 12 into DC power that is then output to the DC link DL.

The VCU 34 is, for example, a DC-DC converter. The VCU 34 steps up electric power supplied from the battery 40, and outputs the stepped-up electric power to the DC link DL.

The control unit 36 includes, for example, a motor controller, a brake controller, and a battery/VCU controller. The motor controller, the brake controller, and the battery/VCU controller may be respectively replaced with separate control devices such as a motor ECU, a brake ECU, and a battery ECU.

The motor controller controls the motor 12 on the basis of outputs from the vehicle sensors 20. The brake controller controls the brake apparatus 16 on the basis of outputs from the vehicle sensors 20. The battery/VCU controller calculates a state of charge (SOC; hereinafter, also referred to as a “battery charging rate”) of the battery 40 on the basis of outputs from the battery sensors 42 attached to the battery 40, and outputs the SOC to the VCU 34 and the display apparatus 70. The battery/VCU controller outputs the calculated SOC of the battery 40 to the communication apparatus 60. The VCU 34 increases a voltage of the DC link DL in response to an instruction from the battery/VCU controller. The motor controller calculates an electricity cost of the vehicle 10 on the basis of outputs from the vehicle sensors 20 and transition in the SOC of the battery 40. The motor controller calculates an electricity cost of the vehicle 10 for each traveling mode.

The battery 40 is a secondary battery such as a lithium-ion battery. The battery 40 accumulates electric power supplied from the external charging/discharging apparatus 200 of the vehicle 10, and releases electric power for traveling of the vehicle 10. The battery sensors 42 include, for example, a current sensor, a voltage sensor, and a temperature sensor. The battery sensors 42 detect, for example, a current value, a voltage value, and the temperature of the battery 40. The battery sensors 42 output the detected current value, voltage value, temperature, and the like to the control unit 36.

The navigation apparatus 50 includes, for example, a global navigation satellite system (GNSS) receiver 52, a navigation human machine interface (HMI) 54, and a route determiner 56. The navigation apparatus 50 stores map information 58 in a storage device such as a hard disk drive (HDD) or a flash memory. The GNSS receiver 52 periodically identifies a position of the vehicle 10 on the basis of a signal received from a GNSS satellite. A position of the vehicle 10 may be identified or supplemented by an inertial navigation system (INS) using outputs from the vehicle sensors 20. The navigation HMI 54 includes a display device, a speaker, a touch panel, keys, and the like. The navigation HMI 54 may be partially or entirely integrated into the display apparatus 70. The GNSS receiver 52 outputs the identified position of the vehicle to the communication apparatus 60. The route determiner 56 determines, for example, a guidance route from a position of the vehicle 10 identified by the GNSS receiver 52 to a destination that is entered by a user of the vehicle 10 by using the navigation HMI 54 by referring to the map information 58. The map information 58 is, for example, information in which a road shape is expressed by a link indicating a road and nodes connected to each other via the link. The map information 58 may include a curvature of a road, point of interest (POI) information, and the like. The POI information may include, for example, information regarding a position of a facility or a store on a map. For example, in a case where a home is set as a destination by the user of the vehicle 10 by using the navigation HMI 54, the route determiner 56 recognizes the set position as a position of the home of the user of the vehicle 10, and outputs the recognized position of the home to the communication apparatus 60.

The communication apparatus 60 includes a wireless module for connection to a cellular network or a Wi-Fi network. The communication apparatus 60 transmits the SOC of the battery 40 output from the battery/VCU controller of the control unit 36, to the management apparatus 100 via a network NW. The communication apparatus 60 transmits the position of the vehicle 10 acquired from the GNSS receiver 52 of the navigation apparatus 50, to the management apparatus 100 via the network NW. The communication apparatus 60 transmits the position of the home of the user of the vehicle 10 recognized by the route determiner 56 of the navigation apparatus 50, to the management apparatus 100 via the network NW.

The display apparatus 70 includes, for example, a display unit 72 and a display control unit 74. The display unit 72 is configured with, for example, a liquid crystal display, and displays information in accordance with control of the display control unit 74. The display control unit 74 displays an image based on information transmitted from the management apparatus 100 on the display unit 72 according to information output from the control unit 36 and the communication apparatus 60. The display control unit 74 displays a vehicle speed and the like output from the vehicle sensors 20 on the display unit 72.

The charging port 80 is provided outward of a vehicle body of the vehicle 10. The charging port 80 is connected to the charging/discharging apparatus 200 via a charging cable 220. The charging cable 220 is provided with a first plug 222 and a second plug 224. The first plug 222 is connected to the charging/discharging apparatus 200, and the second plug 224 is connected to the charging port 80. Electric power supplied from the charging/discharging apparatus 200 is supplied to the charging port 80 via the charging cable 220. Electric power supplied to the charging port 80 from the battery 40 is supplied to the charging/discharging apparatus 200 via the charging cable 220.

The charging cable 220 includes a signal cable added to a power cable. The signal cable relays communication between the vehicle 10 and the charging/discharging apparatus 200. Therefore, each of the first plug 222 and the second plug 224 is provided with a power connector and a signal connector.

The converter 82 is provided between the charging port 80 and the battery 40. The converter 82 converts a current introduced from the charging/discharging apparatus 200 via the charging port 80, for example, an AC current into a DC current. The converter 82 outputs the converted DC current to the battery 40. The converter 82 converts a current introduced from the battery 40, for example, a DC current into an AC current. The converter 82 outputs the converted AC current to the charging port 80.

### Management Apparatus

As illustrated in FIG. 1, the management apparatus 100 includes, for example, a communication unit 110, an acquirer 120, a manager 130, and a storage 140. The acquirer 120 and the manager 130 are realized, for example, by a hardware processor such as a central processing unit (CPU) executing a program (software). Some or all of the constituent elements may be realized by hardware (a circuit portion; including a circuitry) such as a large scale integration (LSI), an application specific integrated circuit (ASIC), a field-programmable gate array (FPGA), or a graphics processing unit (GPU), and may be realized by software and hardware in cooperation. The program may be stored in advance in a storage device (a storage device provided with a non-transitory storage medium) such as a hard disk drive (HDD) or a flash memory of the management apparatus 100, and may be stored in an attachable and detachable storage medium (non-transitory storage medium) such as a DVD or a CD-ROM and may be installed in the HDD or the flash memory of the management apparatus 100 when the storage medium is attached to a drive device.

The communication unit 110 includes a communication interface such as an NIC. The communication unit 110 performs transmission and reception of information between a plurality of charging/discharging apparatuses 200 and a power company managing the electric power system 400, via the network NW. The network NW includes, for example, the Internet, a wide area network (WAN), a local area network (LAN), a provider apparatus, and a radio base station. The communication unit 110 receives charge information generated by each of the plurality of charging/discharging apparatuses 200. The charge information includes information such as a voltage or an SOC of the battery 40 of the vehicle 10.

The acquirer 120 acquires a position of the vehicle 10, a first specific location related to the user of the vehicle 10, and power storage information regarding the battery 40 from the vehicle 10, and stores the acquired information into the storage 140. The first specific location related to the user of the vehicle 10 is, for example, a position of the home of the user. The acquirer 120 may directly acquire the position of the home of the user from the vehicle 10, and may estimate the position of the home on the basis of information acquired from the vehicle 10 or the like. The acquirer 120 may estimate a position on which information concentrates in the nighttime as the position of the home of the user of the vehicle 10, for example, on the basis of history information of positions of the vehicle 10 periodically acquired from the vehicle 10. The power storage information regarding the battery 40 includes information such as a voltage or an SOC of the battery 40.

The manager 130 performs control for distributing electric power among the vehicle 10, the building 410, and the electric power system 400. The manager 130 supplies electric power supplied to the electric power system 400 from the vehicle 10, to a power plant included in the electric power system 400 or the building 410 connected to the electric power system 400, or supplies electric power supplied from the electric power system 400 to the vehicle 10 connected to the charging/discharging apparatus 200.

The manager 130 acquires, for example, a distance between the position of the vehicle 10 acquired by the acquirer 120 and the position of the home of the user of the vehicle 10 acquired or estimated by the acquirer 120. The manager 130 transmits, for example, the position of the vehicle 10 acquired by the acquirer 120 and the position of the home of the user of the vehicle 10 acquired or estimated by the acquirer 120 to a navigation server via the communication unit 110, and acquires the distance between the position of the vehicle 10 and the position of the home of the user of the vehicle 10 from the navigation server. The distance between the position of the vehicle 10 and the position of the home of the user of the vehicle 10 from the navigation server may be a straight distance on a map, and may be a distance along a guidance route from the position of the vehicle 10 to the home of the user of the vehicle 10. The manager 130 calculates an SOC of the battery 40 with which the vehicle 10 can travel from the position of the vehicle 10 to the position of the home of the user of the vehicle 10 on the basis of the distance acquired from the navigation server.

The storage 140 is realized by, for example, an HDD, a flash memory, an EEPROM, a read only memory (ROM), or a random access memory (RAM). The storage 140 stores, for example, charging data 142 and other information.

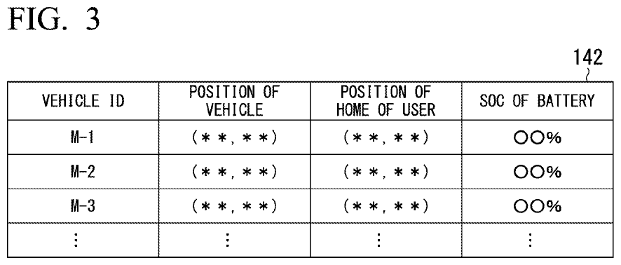

FIG. 3 is a diagram illustrating an example of the charging data 142 according to the first embodiment. In the charging data 142, for example, a vehicle ID is correlated with a position of the vehicle 10, a position of a home of a user of the vehicle 10, and an SOC of the battery 40. The vehicle ID may be an ID (identification information) of the vehicle 10 connected to the charging/discharging apparatus 200, and may be information indicating a vehicle type of the vehicle 10.

The manager 130 refers to the charging data 142, and acquires the SOC of the battery 40. The manager 130 determines a value obtained by subtracting an SOC of the battery 40 with which the vehicle 10 can travel to the home of the user from the SOC of the battery 40, as a lower limit value of an amount of electric power supplied to the electric power system 400 from the vehicle 10. The manager 130 determines an amount of electric power supplied to the electric power system 400 from the battery 40 of the vehicle 10 via the charging/discharging apparatus 200 only to the extent of the determined lower limit value of an amount of electric power.

In a case where a charging facility is present at an intermediate position between the position of the vehicle 10 and the first specific location, the manager 130 sets a position of the charging facility as a second specific location, and calculates an SOC of the battery 40 with which the vehicle 10 can travel to the second specific location. The manager 130 determines a value obtained by subtracting an SOC of the battery 40 with which the vehicle 10 can travel to the second specific location from the SOC of the battery 40, as a lower limit value of an amount of electric power supplied to the electric power system 400 from the vehicle 10. The manager 130 determines an amount of electric power supplied to the electric power system 400 from the battery 40 of the vehicle 10 via the charging/discharging apparatus 200 only to the extent of the determined lower limit value of an amount of electric power.

In a case where a third specific location that is different from the first specific location is estimated as a destination of the vehicle 10 in association with schedule information of the user of the vehicle 10, the manager 130 calculates an SOC of the battery 40 with which the vehicle 10 can travel to the third specific location. The case where the third specific location is estimated as a destination of the vehicle 10 is, for example, a case where a facility that the user of the vehicle 10 is scheduled to visit is registered in the schedule information in correspondence with a time period in which the vehicle 10 is scheduled to depart while the vehicle 10 is connected to the charging/discharging apparatus 200. The manager 130 determines a value obtained by subtracting an SOC of the battery 40 with which the vehicle 10 can travel to the third specific location from the SOC of the battery 40, as a lower limit value of an amount of electric power supplied to the electric power system 400 from the vehicle 10. The manager 130 determines an amount of electric power supplied to the electric power system 400 from the battery 40 of the vehicle 10 via the charging/discharging apparatus 200 only to the extent of the determined lower limit value of an amount of electric power.

### Charging/Discharging Apparatus

As illustrated in FIG. 1, the charging/discharging apparatus 200 includes a casing 202, a control device 204, and a cable connection port 208.

The control device 204 is built into the casing 202, and can perform communication with the vehicle 10, the management apparatus 100, and a power company managing the electric power system 400 via the network NW. The control device 204 controls transmission and reception of electric power between the electric power system 400 and the charging/discharging apparatus 200 on the basis of input information from an input device (not illustrated) provided outside the casing 202 or information provided from the vehicle 10, the management apparatus 100, and the power company.

The cable connection port 208 is formed to be open on an outer surface of the casing 202. The charging cable 220 is connectable to the cable connection port 208.

The charging cable 220 includes a first plug 222 and a second plug 224. The first plug 222 is connected to the cable connection port 208 of the charging/discharging apparatus 200, and the second plug 224 is connected to the charging port 80 of the vehicle 10.

In a case where the vehicle 10 is connected to the charging/discharging apparatus 200, the control device 204 detects connection of the vehicle 10, and outputs a detection signal to the management apparatus 100 via the network NW. The detection signal includes, for example, identification information (ID) of the charging/discharging apparatus 200 and information regarding an SOC of the battery 40 of the vehicle 10 connected to the charging/discharging apparatus 200. The management apparatus 100 identifies the charging/discharging apparatus 200 connected to the vehicle 10 among a plurality of charging/discharging apparatuses 200 connected to the electric power system 400 on the basis of the detection signal acquired from the charging/discharging apparatus 200 via the network NW. The management apparatus 100 stores, for example, correspondence information in which an ID of the charging/discharging apparatus 200 is correlated with a position where the charging/discharging apparatus 200 is provided in the storage 140, and acquires a position of the charging/discharging apparatus 200 connected to the vehicle 10 as a position of the vehicle 10 by referring to the correspondence information. The management apparatus 100 acquires an SOC of the battery 40 of the vehicle 10 connected to the charging/discharging apparatus 200 on the basis of the detection signal acquired from the charging/discharging apparatus 200 via the network NW. The management apparatus 100 stores the acquired position of the vehicle 10 and the acquired SOC of the battery 40 of the vehicle 10 into the storage 140 as the charging data 142 in correlation with the ID of the vehicle 10 connected to the charging/discharging apparatus 200.

Here, the V2G will be described. The V2G is a system in which, when the vehicle 10 is not used as moving means, the battery 40 mounted on the vehicle 10 is used as an electric power storage facility, and electric power is transmitted and received in a bidirectional manner between the vehicle 10 and the electric power system 400 participating in the V2G.

The vehicle 10 participating in the V2G performs continuous discharging for maintaining the supply-demand balance in the electric power system 400 or charging and discharging for stabilizing a frequency in the electric power system 400, depending on a status of the electric power system 400. Electric power obtained through continuous discharging of the vehicle 10 for maintaining the supply-demand balance is used as a “spinning reserve” of the electric power system 400. The continuous discharging for the spinning reserve is performed to supply electric power to the electric power system 400, the electric power being necessary to maintain the supply-demand balance, for example, due to an increase in power demand in the electric power system 400.

### Process Flow in Management Apparatus

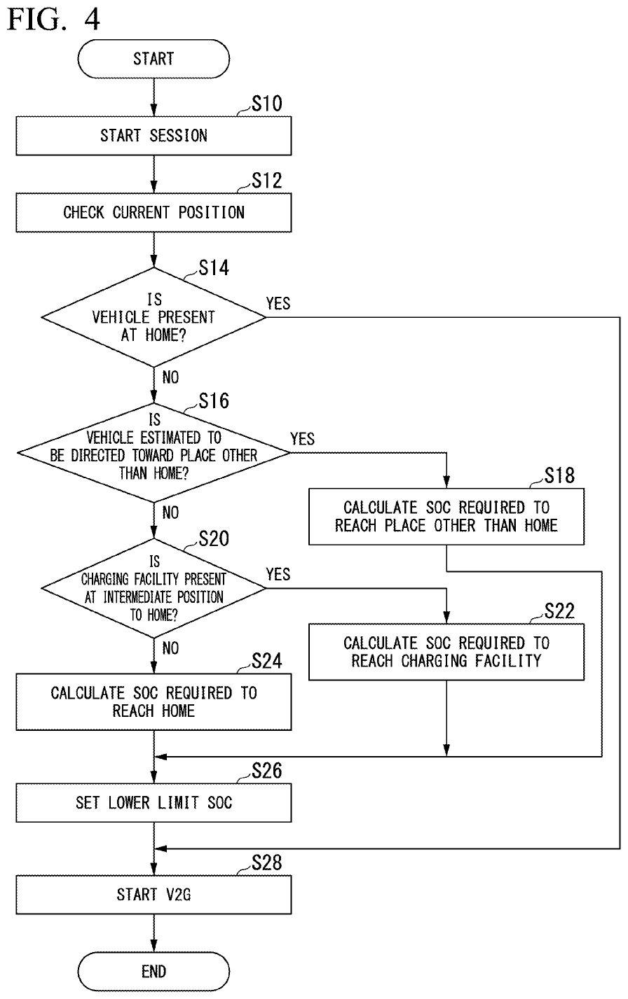

Hereinafter, with reference to a flowchart, a description will be made of a flow of a series of processes in the management apparatus 100 according to the first embodiment. FIG. 4 is a flowchart for describing a flow of a series of processes in the management apparatus 100 according to the first embodiment. The processes in the flowchart may be started, for example, in a case where the management apparatus 100 acquires a detection signal from the charging/discharging apparatus 200 via the network NW.

First, in a case where a detection signal is acquired from the charging/discharging apparatus 200 via the network NW, the manager 130 starts a session with the vehicle 10 connected to the charging/discharging apparatus 200 (step S10). In a case where the session is started, the manager 130 checks the current position of the vehicle 10 on the basis of the detection signal acquired from the charging/discharging apparatus 200 (step S12). Next, the manager 130 determines whether or not the vehicle 10 is present at a home of a user (step S14). In this case, for example, the manager 130 may collate an ID of the charging/discharging apparatus 200 connected to the vehicle 10 with an ID of the charging/discharging apparatus 200 provided at the home of the user, and may determine that the vehicle is present at the home of the user in a case where the collation is established.

In a case where it is determined that the vehicle 10 is not present at the home of the user, the manager 130 determines whether or not the vehicle 10 is estimated to be directed toward a place other than the home of the user (step S16). In this case, for example, when a facility that the user of the vehicle 10 is scheduled to visit is registered in the schedule information in correspondence with a time period in which the vehicle 10 is scheduled to depart, the manager 130 may estimate that the vehicle 10 is directed toward the facility that the user of the vehicle is scheduled to visit. In a case where it is estimated that the vehicle 10 is directed toward a place other than the home of the user, the manager 130 calculates an SOC of the battery 40 required for the vehicle 10 to reach the place other than the home of the user (step S18). On the other hand, in a case where it is estimated that the vehicle 10 is not directed toward a place other than the home of the user, the manager 130 determines whether or not there is a charging facility at an intermediate position to the home of the user (step S20). In this case, the manager 130 may transmit, for example, the position of the charging/discharging apparatus 200 connected to the vehicle 10 and the position of the home of the user to the navigation server, and may inquire of the navigation server about whether or not there is a charging facility at an intermediate position to the home of the user. In a case where it is determined that there is a charging facility at an intermediate position to the home of the user, the manager 130 calculates an SOC of the battery 40 for the vehicle 10 to reach the charging facility (step S22). On the other hand, in a case where it is determined that there is no charging facility at an intermediate position to the home of the user, the manager 130 calculates an SOC of the battery 40 for the vehicle 10 to travel to the home of the user (step S24).

Next, the manager 130 sets a lower limit value of an SOC during the V2G by subtracting the SOC of the battery 40 calculated in step S18, step S22, or step S24 from the SOC of the battery 40 acquired from the charging data 142 (step S26). The manager 130 starts the V2G and supplies electric power to the electric power system 400 from the vehicle 10 via the charging/discharging apparatus 200 only to the extent of the lower limit value of the SOC during the V2G (step S28). Consequently, the processes in the flowchart are finished.

In the flowchart of FIG. 4, the determination processes in step S16 and step S20 may be omitted, and, in a case where it is determined that the vehicle 10 is present at the home of the user in step S14, the manager 130 may calculate an SOC of the battery 40 required for the vehicle 10 to travel to the home of the user, and may set a lower limit value of the SOC during the V2G on the basis of the calculated SOC of the battery 40.

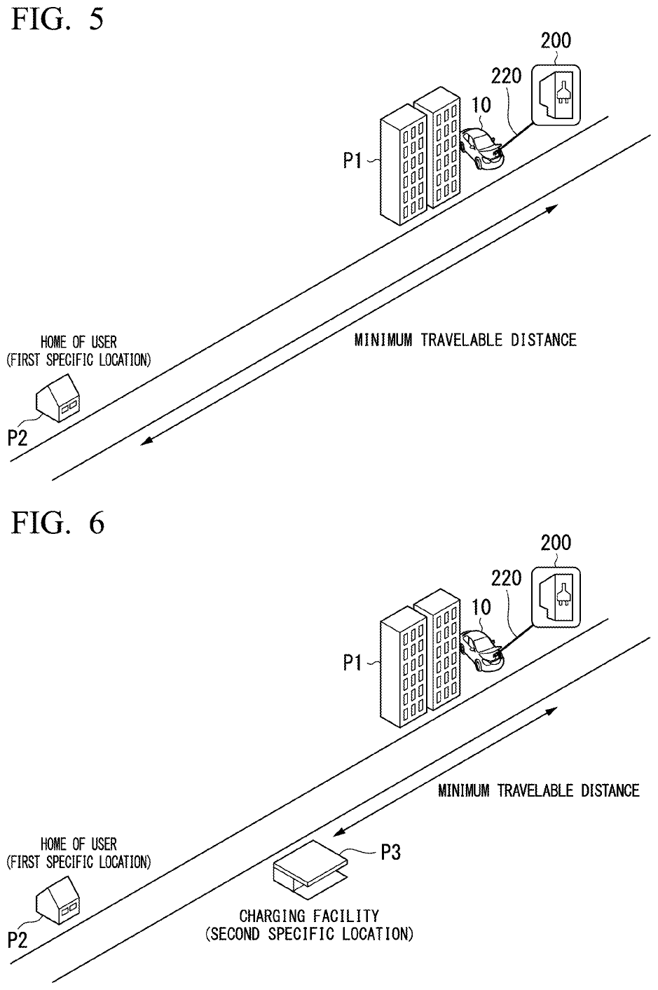

FIGS. 5 to 7 are diagrams for describing an operation of the management apparatus 100 according to the first embodiment. In the illustrated examples, a description will be made of an example of a case where a user of the vehicle 10 parks the vehicle 10 to be connected to the charging/discharging apparatus 200 when the user goes to a company P1.

In the example illustrated in FIG. 5, the management apparatus 100 calculates an SOC with which the vehicle 10 can travel from a position of the company P1 to a position of a home P2 of the user. The management apparatus 100 subtracts the calculated SOC from an SOC of the battery 40 of the vehicle 10, and thus manages an amount of electric power supplied to the electric power system 400 from the vehicle 10 parked at the company via the charging/discharging apparatus 200. Consequently, a minimum of the SOC of the battery 40 required for the vehicle 10 to travel from the company P1 to the home of the user is secured, and the V2G is also operated.

In the example illustrated in FIG. 6, since a charging facility P3 is present at an intermediate position between the company P1 and the home P2 of the user, the management apparatus 100 sets the charging facility P3 as the second specific location, and calculates an SOC of the battery 40 with which the vehicle 10 can travel to the second specific location. The management apparatus 100 subtracts the calculated SOC from an SOC of the battery 40 of the vehicle 10, and thus manages an amount of electric power supplied to the electric power system 400 from the vehicle 10 parked at the company via the charging/discharging apparatus 200. Consequently, a minimum of the

SOC of the battery 40 required for the vehicle 10 to travel from the company P1 to the charging facility P3 is secured, and the V2G is also operated.

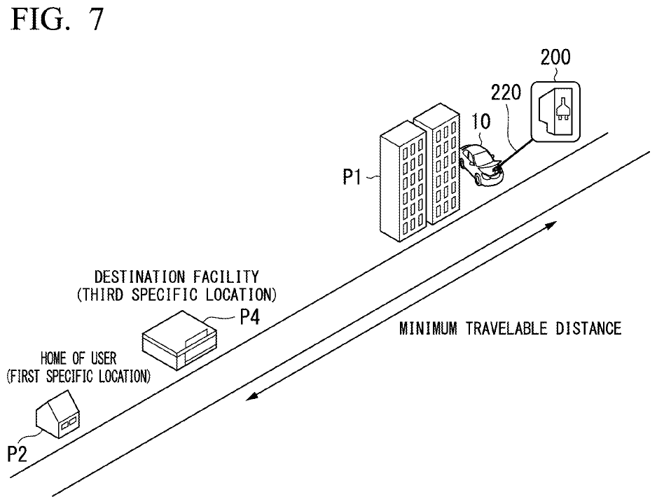

In the example illustrated in FIG. 7, since a facility P4 that is a destination of the user of the vehicle 10 is registered in the schedule information in correspondence with a time period in which the vehicle 10 is scheduled to depart, the management apparatus 100 sets the facility P4 that is a destination as the third specific location, and calculates an SOC of the battery 40 with which the vehicle 10 can travel to the third specific location. The management apparatus 100 subtracts the calculated SOC from an SOC of the battery 40 of the vehicle 10, and thus manages an amount of electric power supplied to the electric power system 400 from the vehicle 10 parked at the company P1 via the charging/discharging apparatus 200. Consequently, a minimum of the SOC of the battery 40 required for the vehicle 10 to travel from the company P1 to the facility P4 that is a destination is secured, and the V2G is also operated.

The management apparatus 100 according to the first embodiment can operate the V2G while securing a minimum power storage amount. For example, during movement to the home, in a case where electric power is supplied to the electric power system 400 from the battery 40 of the vehicle 10, it may be difficult for the vehicle 10 to travel to the home due to an insufficient power storage amount of the battery 40 of the vehicle 10. Therefore, the management apparatus 100 according to the first embodiment sets a lower limit value of an SOC during the V2G, and thus secures an SOC of the battery 40 with which the vehicle 10 can travel to the home of the user. Thus, it is possible to operate the V2G while securing a minimum power storage amount.

### Second Embodiment

Hereinafter, a second embodiment will be described. The second embodiment is different from the first embodiment in terms of a method of setting a lower limit value of an SOC during V2G. Hereinafter, a description will focus on this difference.

In a case where a position of the vehicle 10 matches the first specific location, the manager 130 sets a fourth specific location that is different from the first specific location, and calculates an SOC of the battery 40 with which the vehicle 10 can travel to the fourth specific location. The first specific location is, for example, a position of the home of the user of the vehicle 10, and the fourth specific location is, for example, a facility that the user is scheduled to visit, registered in the schedule information of the user. In a case where the position of the vehicle 10 matches the first specific location, the manager 130 determines a value obtained by subtracting, from the SOC of the battery 40, an SOC of the battery 40 with which the vehicle 10 can travel to the fourth specific location from the position of the vehicle 10, as a lower limit value of an amount of electric power supplied to the electric power system 400 from the battery 40 of the vehicle 10 only to the extent of the value. The manager 130 determines an amount of electric power supplied to the electric power system 400 from the battery 40 of the vehicle 10 via the charging/discharging apparatus 200 only to the extent of the determined lower limit value of an amount of electric power. In this case, for example, when the charging/discharging apparatus 200 is provided at the home of the user of the vehicle 10, the manager 130 may perform collation among the charging/discharging apparatuses 200 on the basis of a detection signal acquired from the charging/discharging apparatus 200 provided at the home of the user via the network NW, and may determine whether or not the position of the vehicle 10 matches the position of the home of the user of the vehicle 10.

In a case where a charging facility is present at an intermediate position between the position of the vehicle 10 and the fourth specific location, the manager 130 sets a position of the charging facility as a fifth specific location, and calculates an SOC of the battery 40 with which the vehicle 10 can travel to the fifth specific location. The manager 130 determines a value obtained by subtracting an SOC of the battery 40 with which the vehicle 10 can travel to the fifth specific location from the SOC of the battery 40, as a lower limit value of an amount of electric power supplied to the electric power system 400 from the vehicle 10. The manager 130 determines an amount of electric power supplied to the electric power system 400 from the battery 40 of the vehicle 10 via the charging/discharging apparatus 200 only to the extent of the determined lower limit value of an amount of electric power.

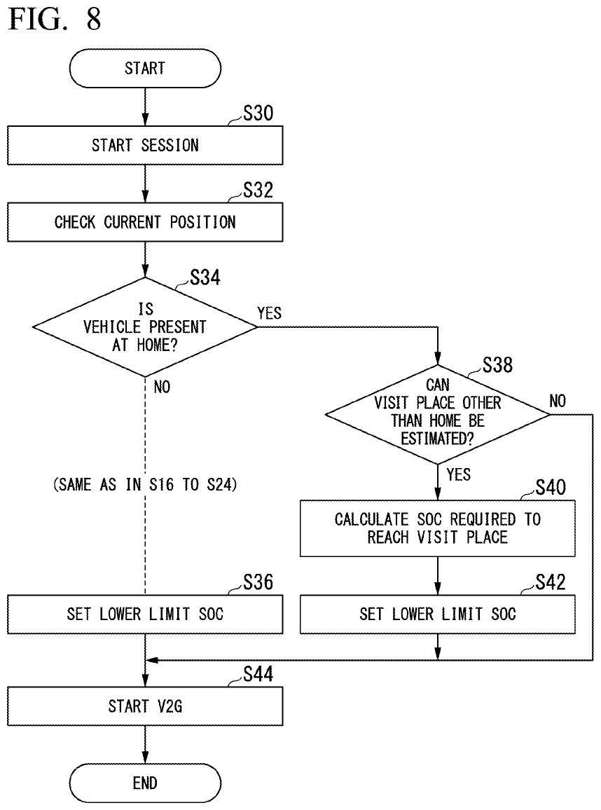

Hereinafter, with reference to a flowchart, a description will be made of a flow of a series of processes in the management apparatus 100 according to the second embodiment. FIG. 8 is a flowchart for describing a flow of a series of processes in the management apparatus 100 according to the second embodiment. The processes in the flowchart may be started, for example, in a case where the management apparatus 100 acquires a detection signal from the charging/discharging apparatus 200 via the network NW.

First, in a case where a detection signal is acquired from the charging/discharging apparatus 200 via the network NW, the manager 130 starts a session with the vehicle 10 connected to the charging/discharging apparatus 200 (step S30). In a case where the session is started, the manager 130 checks the current position of the vehicle 10 on the basis of the detection signal acquired from the charging/discharging apparatus 200 (step S32). Next, the manager 130 determines whether or not the vehicle 10 is present at a home of a user (step S34). In a case where it is determined that the vehicle 10 is not present at the home of the user, the manager 130 sets a lower limit value of an SOC during V2G by performing the same processes as in step S16 to step S24 in the flowchart of FIG. 4 (step S36). In a case where it is determined that the vehicle 10 is present at the home of the user, the manager 130 determines whether or not a visit place other than the home of the user can be estimated (step S38). In this case, the manager 130 may determine whether or not a visit place other than the home of the user can be estimated on the basis of whether or not the visit place other than the home of the user is registered in schedule information. In a case where it is determined that a visit place other than the home of the user can be estimated, the manager 130 calculates an SOC of the battery 40 required for the vehicle 10 to reach the estimated visit place (step S40). Next, the manager 130 sets a lower limit value of an SOC during the V2G by subtracting the SOC of the battery 40 calculated in step S40 from the SOC of the battery 40 acquired from the charging data 142 (step S42). On the other hand, in a case where it is determined that a visit place other than the home of the user cannot be estimated, the manager 130 skips processes in step S40 and step S42, and proceeds to step S44. The manager 130 starts the V2G and supplies electric power to the electric power system 400 from the vehicle 10 via the charging/discharging apparatus 200 (step S44). In this case, when the lower limit value of an SOC during the V2G is set in step S36 or step S42, the manager 130 starts the V2G and supplies electric power to the electric power system 400 from the vehicle 10 via the charging/discharging apparatus 200 only to the extent of the lower limit value of the SOC during the V2G. Consequently, the processes in the flowchart are finished.

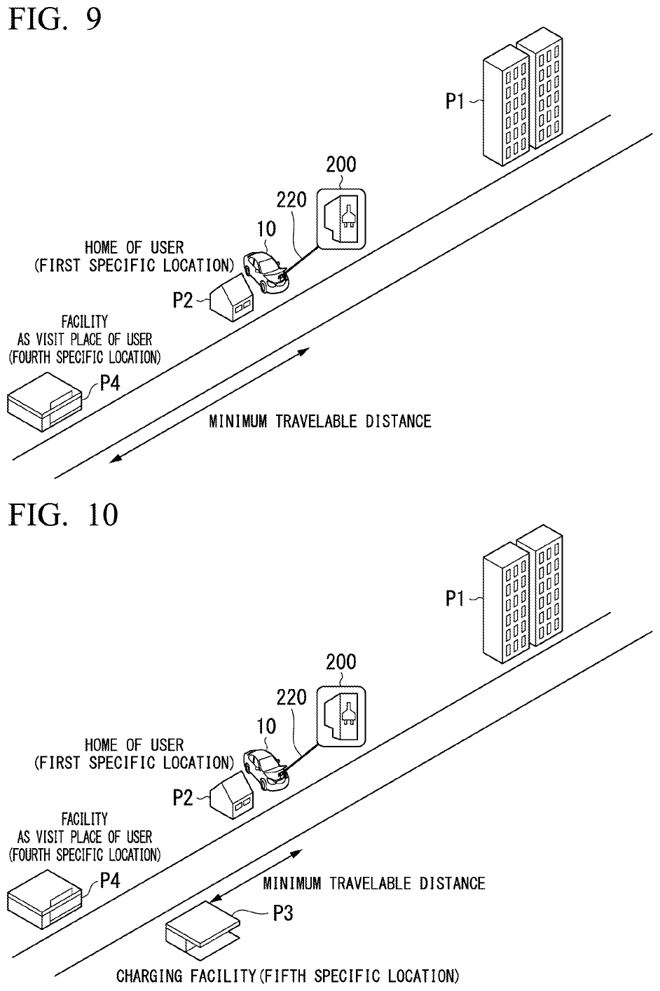

FIGS. 9 and 10 are diagrams for describing an operation of the management apparatus 100 according to the second embodiment. In the illustrated examples, a description will be made of an example of a case where the vehicle 10 is parked to be connected to the charging/discharging apparatus 200 when the vehicle 10 arrives at a home P2 of a user.

In the example illustrated in FIG. 9, since a facility other than the home of the user is estimated as a visit place of the user, the management apparatus 100 sets a facility P4 that is a visit place of the user as the fourth specific location, and calculates an SOC of the battery 40 with which the vehicle 10 can travel to the fourth specific location. The management apparatus 100 subtracts the calculated SOC from an SOC of the battery 40 of the vehicle 10, and thus manages an amount of electric power supplied to the electric power system 400 from the vehicle 10 parked at the home P2 of the user via the charging/discharging apparatus 200. Consequently, a minimum of the SOC of the battery 40 required for the vehicle 10 to travel from the home P2 of the user to the facility P4 that is a visit place of the user is secured, and the V2G is also operated.

In the example illustrated in FIG. 10, since a charging facility P5 is present at an intermediate position between the home P2 of the user and the facility P4 that is a visit place of the user, the management apparatus 100 sets the charging facility P5 as the fifth specific location, and calculates an SOC of the battery 40 with which the vehicle 10 can travel to the fifth specific location. The management apparatus 100 subtracts the calculated SOC from an SOC of the battery 40 of the vehicle 10, and thus manages an amount of electric power supplied to the electric power system 400 from the vehicle 10 parked at the home P2 of the user via the charging/discharging apparatus 200. Consequently, a minimum of the SOC of the battery 40 required for the vehicle 10 to travel from the home P2 of the user to the charging facility P5 is secured, and the V2G is

The management apparatus 100 according to the second embodiment can achieve the same effect as the management apparatus 100 according to the first embodiment, and can also increase the versatility in a case of using the V2G. For example, in a case where the vehicle 10 is located at the home P2 of the user, the management apparatus 100 registers a position other than the home P2 of the user of the vehicle 10 as a specific location, and sets a lower limit value of an SOC during the V2G such that the vehicle 10 can travel to the specific location. Thus, it is possible to increase the versatility in a case of operating the V2G.

### Third Embodiment

Hereinafter, a third embodiment will be described. The third embodiment is different from the first embodiment in that a management apparatus is mounted on a vehicle. Hereinafter, a description will focus on this difference.

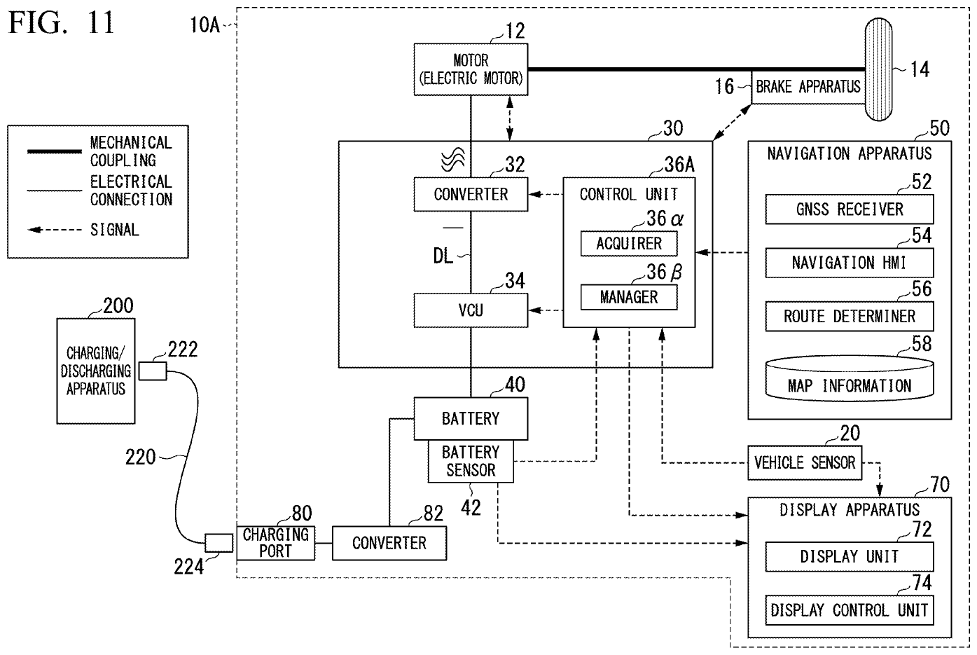

FIG. 11 is a diagram illustrating a configuration of a vehicle 10A according to the third embodiment. As illustrated in FIG. 11, the vehicle 10A is provided with, for example, a motor 12, drive wheels 14, a brake apparatus 16, vehicle sensors 20, a power control unit (PCU) 30, the battery 40, battery sensors 42 such as a voltage sensor, a current sensor, and a temperature sensor, a navigation apparatus 50, a communication apparatus 60, a display apparatus 70, a charging port 80, and a converter 82.

A control unit 36A includes, for example, an acquirer 36α and a manager 36β. Each of the constituent elements of the control unit 36A is realized, for example, by a hardware processor such as a CPU executing a program (software). Some or all of the constituent elements may be realized by hardware (a circuit portion; including a circuitry) such as an LSI, an ASIC, a FPGA, or a GPU, and may be realized by software and hardware in cooperation. The program may be stored in advance in a storage device (a storage device provided with a non-transitory storage medium) such as a hard disk drive (HDD) or a flash memory, and may be stored in an attachable and detachable storage medium (non-transitory storage medium) such as a DVD or a CD-ROM and may be installed when the storage medium is attached to a drive device.

The acquirer 36α acquires a position of the vehicle 10, a first specific location related to a user of the vehicle 10, and power storage information regarding the battery 40. The first specific location related to the user of the vehicle 10 is, for example, a position of the home of the user. The acquirer 36α acquires a position of the vehicle 10 identified by, for example, the GNSS receiver 52 from the navigation apparatus 50. The acquirer 36α may directly acquire the position of the home of the user registered in the map information 58 from the navigation apparatus 50, and may estimate the position of the home on the basis of information acquired from the navigation apparatus 50 or the like. The acquirer 36α may estimate the position of the home of the user of the vehicle 10, for example, on the basis of history information of positions of the vehicle 10 periodically acquired from the navigation apparatus 50. The acquirer 36α acquires power storage information of the battery 40 on the basis of outputs from the battery sensors 42. The power storage information regarding the battery 40 includes information such as a voltage or an SOC of the battery 40. The acquirer 36α acquires a distance between the position of the vehicle 10 and the position of the home of the user of the vehicle 10 from the navigation apparatus 50.

The manager 36β calculates an SOC of the battery 40 with which the vehicle 10 can travel from the position of the vehicle 10 to the position of the home of the user of the vehicle 10 on the basis of the distance acquired from the navigation apparatus 50. The manager 36β determines a value obtained by subtracting the SOC of the battery 40 with which the vehicle can travel to the home of the user from the SOC of the battery 40, as a lower limit value of an amount of electric power supplied to the electric power system 400 from the vehicle 10. The vehicle 10 supplies electric power to the electric power system 400 from the battery 40 of the vehicle 10 via the charging/discharging apparatus 200 only to the extent of the lower limit value of an amount of electric power determined by the manager 36β.

The management apparatus 100 according to the third embodiment achieves the same effect as the management apparatus 100 according to the first embodiment.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A management apparatus comprising a processor,
wherein, the processor is configured to:
control transmission and reception of electric power between a secondary battery mounted on a vehicle and accumulating the electric power used for traveling of the vehicle, and an electric power system,
acquire a position of the vehicle, a first specific location related to a user of the vehicle, and power storage information regarding the secondary battery; and
determine an amount of electric power supplied to the electric power system from the secondary battery only to the extent of a power storage amount obtained by subtracting a power storage amount with which the vehicle can travel from the position of the vehicle to the first specific location from a power storage amount of the secondary battery.

2. The management apparatus according to claim 1,
wherein the first specific location is a position of a home of the user, the position being acquired or estimated in advance.

3. The management apparatus according to claim 1,
wherein, in a case where a charging facility is present at an intermediate position between the position of the vehicle and the first specific location, the processor sets a position of the charging facility as a second specific location, and determines an amount of electric power supplied to the electric power system from the secondary battery only to the extent of a power storage amount obtained by subtracting a power storage amount with which the vehicle can travel to the second specific location from the power storage amount of the secondary battery.

4. The management apparatus according to claim 1,
wherein, in a case where a third specific location being different from the first specific location is estimated as a destination of the vehicle on the basis of schedule information of the user of the vehicle, the processor determines an amount of electric power supplied to the electric power system from the secondary battery only to the extent of a power storage amount obtained by subtracting a power storage amount with which the vehicle can travel to the third specific location from the power storage amount of the secondary battery.

5. The management apparatus according to claim 1,
wherein, in a case where the position of the vehicle matches the first specific location, the processor determines an amount of electric power supplied to the electric power system from the secondary battery only to the extent of a power storage amount obtained by subtracting a power storage amount with which the vehicle can travel from the position of the vehicle to a fourth specific location being different from the first specific location, from the power storage amount of the secondary battery.

6. The management apparatus according to claim 5,
wherein, in a case where a charging facility is present at an intermediate position between the position of the vehicle and the fourth specific location, the processor sets a position of the charging facility as a fifth specific location, and determines an amount of electric power supplied to the electric power system from the secondary battery only to the extent of a power storage amount obtained by subtracting a power storage amount with which the vehicle can travel from the position of the vehicle to the fifth specific location from the power storage amount of the secondary battery.

7. A management method of causing a computer to:
control transmission and reception of electric power between a secondary battery mounted on a vehicle and accumulating the electric power used for traveling of the vehicle, and an electric power system;
acquire a position of the vehicle, a first specific location related to a user of the vehicle, and power storage information regarding the secondary battery; and
determine an amount of electric power supplied to the electric power system from the secondary battery only to the extent of a power storage amount obtained by subtracting a power storage amount with which the vehicle can travel from the acquired position of the vehicle to the first specific location from a power storage amount of the secondary battery.

8. A non-transitory computer readable storage medium storing a program causing a computer to:
control transmission and reception of electric power between a secondary battery mounted on a vehicle and accumulating the electric power used for traveling of the vehicle, and an electric power system;
acquire a position of the vehicle, a first specific location related to a user of the vehicle, and power storage information regarding the secondary battery; and
determine an amount of electric power supplied to the electric power system from the secondary battery only to the extent of a power storage amount obtained by subtracting a power storage amount with which the vehicle can travel from the acquired position of the vehicle to the first specific location from a power storage amount of the secondary battery.
